(19) United States
(12) Patent Application Publication
(10) Pub. No.: US 2026/0103309 A1
(43) Pub. Date: Apr. 16, 2026

(54) MULTILAYER ARTICLES WITH A BARRIER, METHOD, AND SYSTEM

(71) Applicant: Plastipak Packaging, Inc., Plymouth, MI (US)

(72) Inventors: Miguel Vieira, Funchal (PT); Aditi Bhattacharyya Ghosh, Wijnegem (BE)

(21) Appl. No.: 19/354,335

(22) Filed: Oct. 9, 2025

Related U.S. Application Data
(60) Provisional application No. 63/705,841, filed on Oct. 10, 2024.

(51) Int. Cl. B65D 1/02; B32B 1/08; B32B 27/08; B32B 27/18; B32B 27/36

(52) U.S. Cl. CPC B65D 1/0215; B32B 1/08; B32B 27/08; B32B 27/18; B32B 27/36; B32B 2250/03; B32B 2250/244; B32B 2272/00; B32B 2307/7242; B32B 2439/60

(57) ABSTRACT

The present disclosure relates to methods and articles for creating multilayer oxygen barriers aimed at reducing discoloration in PET materials within the recycling stream. By employing a multilayer configuration with a concentrated barrier in the middle layer and antioxidant additives in the inner and outer layers in combination with blue toner, the invention addresses the increased need for barrier content in lightweight and recycled PET bottles. This configuration enhances barrier efficiency, minimizes contamination, and reduces yellowing during recycling, making it fully compatible with recycled PET.

### CROSS-REFERENCE TO RELATED APPLICATION

This application claims the benefit of U.S. Provisional Patent Application No. 63/705,841, filed Oct. 10, 2024, which is incorporated by reference herein in its entirety.

### TECHNICAL FIELD

The present disclosure relates to multilayer articles with barriers, including oxygen and/or CO2 barriers, and articles that limit discoloration of polyethylene terephthalate (PET) and which may be compatible with recycling streams with recycled PET. Methods and systems associated with such barriers and articles are also disclosed.

### BACKGROUND

Molding systems and methods may provide molded plastic articles of various configurations. Oxygen barriers are often used in connection with plastic preforms and containers to improve various properties. With some conventional preforms and containers, an increased amount of PCR in PET bottles can lead to increased incompatibility with oxygen scavengers. Recycled PET may consist of various contaminants from colorants, additives, barriers, and other packaging materials, which may significantly impact the activation of oxygen scavengers, leading to increased incompatibility. Additionally, incompatibility can be more prominent in lightweight containers due to reduced bottle wall thickness.

Oxygen barriers/additives, whether nylon-based or not, may introduce contamination that results in coloration (e.g., “yellowing”) in the recycling stream. Inclusion of an antioxidant may reduce yellowing associated with some articles when combined with a blue toner, and can provide a more “bluish” visual impression.

Challenges exist with using oxygen barriers in various plastic containers, including multilayered plastic containers, as the addition of antioxidant additives or light-weighting of bottles can reduce the effectiveness of the oxygen barriers.

Moreover, an increased amount of recycled content, such as post-consumer recycled (PCR) content in polyethylene terephthalate (PET) bottles or containers, commonly exacerbates or increases incompatibility with oxygen scavengers. A higher amount of an oxygen scavenger is typically required to achieve desired oxygen barrier performance; however, that can lead to greater contamination risk and increased costs. Moreover, there can be a negative impact on recycling efforts associated with higher levels of contamination.

The inclusion of some reheat additives in combination with oxygen scavenger can also cause detrimental effect on the barrier performance. Also, the inclusion of anti-yellowing additives may interfere in the oxidation reaction due to several factors, e.g., some anti-yellowing additives may contain antioxidants that directly inhibit the activity of oxygen scavengers.

There is a need to provide barriers, articles, methods, and systems that address one or more of the present challenges.

### SUMMARY

Aspects of the present disclosure include multilayer articles, such as a plastic preforms or containers comprising multiple layers. Such multiple layers may include a middle or intermediate layer (e.g., PET and/or polyethylene furanoate (PEF) layer, with or without PCR content) and a barrier, and inner and outer layers comprised of PET (with or without PCR content). Such embodiments may reduce the content of oxygen scavengers overall in a preform, which can, inter alia, lower coloration in connection with recycling efforts. With some embodiments, a middle or intermediate layer may comprise about 2% to about 25% of a total cross-sectional wall thickness of the multilayer preform or container. In embodiments, a barrier layer may be isolated from inner and outer layers. The inner and outer layers may contain antioxidant additives that may be combined with blue toner to, for example, compensate for yellowing during recycling without interfering with the oxygen scavenging properties of an incorporated oxygen and/or carbon dioxide (CO2) barrier.

### BRIEF DESCRIPTION OF THE DRAWINGS

Embodiments of the disclosure will now be described by way of example with reference to the accompanying drawings wherein:

FIGS. 1A and 1B generally illustrate a cross-sectional views of embodiments of a wall portion of a monolayer and a multilayer article, respectively.

FIG. 2 is a graph generally illustrating an aspect of barrier performance (oxygen ingress over time) in connection with monolayer containers.

FIG. 3 is a graph generally illustrating an aspect of barrier performance (oxygen ingress over time) in connection lightweight bottles with a lower wall thickness.

FIG. 4 is a graph generally illustrating an aspect of barrier performance (oxygen ingress over time) in connection with monolayer containers with a higher barrier content.

FIG. 5 is a table generally illustrating an impact of mono barrier increase on the color and haze of a bottle.

FIG. 6 is a graph generally illustrating an aspect of barrier performance (oxygen ingress over time) in connection with multilayer structures associated with embodiments of the present disclosure.

FIG. 7 is a graph generally illustrating an aspect of barrier performance (oxygen ingress over time) in connection with multilayer articles including recycled PET.

FIGS. 8A and 8B are graphs generally illustrating an aspect of barrier performance (oxygen ingress over time) in connection with multilayer articles without an additive and in combination with antioxidant additive with blue toner including in an inner and outer layer.

FIGS. 9A and 9B are tables generally demonstrating color variation of different multilayer articles (nylon-based and nylon-free) with and without an antioxidant additive in an inner and outer layer.

### DETAILED DESCRIPTION

Reference will now be made in detail to embodiments of the present disclosure, examples of which are described herein and illustrated in the accompanying drawings. While the invention will be described in conjunction with embodiments, it is understood that they are not intended to limit the invention to these embodiments. Instead, the invention is intended to cover alternatives, modifications, and equivalents within the spirit and scope of the invention as defined herein and by appended claims.

The present disclosure involves, inter alia, multilayer articles, such as plastic preforms or containers. In embodiments, post-consumer recycled (PCR) material may or may not be separated from an oxygen scavenger. With some embodiments, PCR may be used in connection with PET layers and an oxygen scavenger may be disposed in a middle or intermediate layer. Unless otherwise specified, such as with respect to wall thicknesses, the references to percentages in this disclosure refer to percentages by weight or total weight of an associated article.

It can be desirable to minimize the amount of an oxygen scavenger, such as to minimize contaminants in a PET stream and to improve recyclability. Embodiments of the disclosure may utilize comparatively powerful oxygen scavenging materials (e.g., a nylon-free solution) to reduce the amount of such included material. By employing a multilayer (or “ML”) configuration, with embodiments the quantity of an oxygen scavenger may be reduced, and may potentially be significantly reduced. For example, a 2.5% nylon-free oxygen scavenger in a monolayer structure may provide good performance. However, in accordance with embodiments of the disclosure, it may be improved by using 10% middle or intermediate layer containing 6.5% nylon-free oxygen scavenger mixed (e.g., blended) with PET, PEF, and/or other polymers, which may result in a total preform containing only 0.65% of barrier. Such configurations with a multilayer bottle can provide an increased diffusion path length, and improved barrier performance.

Multilayer configurations with reduced barrier content (e.g., compared to monolayer configurations) may not only impact the shelf life, color, and haze of the bottles but may also enhance sustainability. Use of less barrier content can, among other things, reduce contamination in the recycling stream, which can decrease yellowing of the PET due to heat exposure and thermal degradation in combination with nylon or nylon-free oxygen scavengers. Additionally, CO2 barriers may comprise, for example and without limitation, nylon based barriers or PEF, as well as other copolyesters.

In embodiments, including an antioxidant additive and blue toner in PET layers of an article may reduce yellowing associated with the article's composition. However, the use of additives in combination with barrier material can impact barrier performance of the bottles. Therefore, in embodiments, a suitable antioxidant additive may be selected and used, for example, at a given let-down ratio (LDR) or percent LDR. An LDR may refer to a percentage or ratio at which a concentrated mixture with an additive is mixed with a base polymer or resin (e.g., PET). Further, in a multilayer configuration, additives can be incorporated in the outer layers to separate them from the barrier layer, which may be a middle or intermediate layer. With some embodiments, significant benefits may be achieved with the addition of a toner (e.g., blue toner) in combination with an antioxidant additive (or additives).

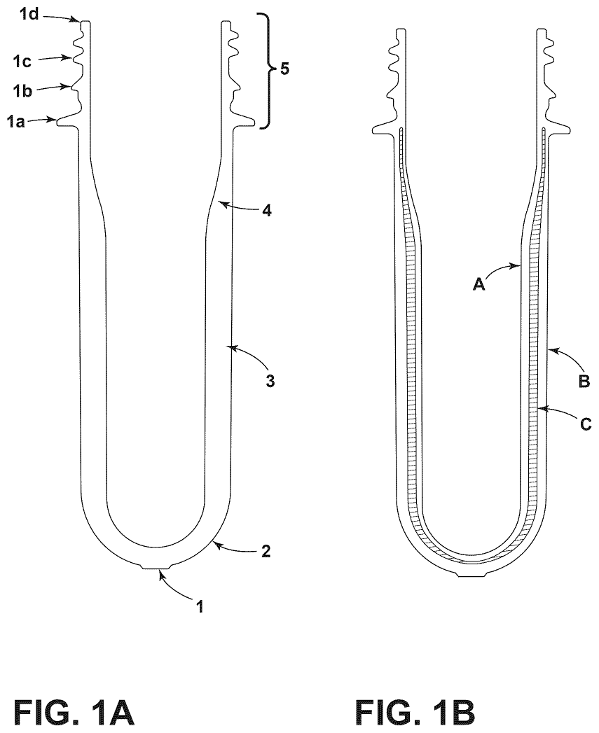

Embodiments of the present disclosure may provide a multilayer configuration or structure in which a middle or intermediate layer comprises or includes a barrier or barrier material. With reference to FIG. 1A, a preform is generally illustrated. The preform may be a multilayer preform and may include a preform gate 1, a preform base 2, a preform body 3, a preform transition 4, and a preform finish 5. The preform finish 5 may comprise a support ring 1a, a tamper-evident feature or pilfer ring 1b, threading 1c, and a surface sealing surface 1d. The middle or intermediate layer can be separate and isolated from (e.g., restricted from chemical interaction with) other layers of a multilayer article, including an inner layer and an outer layer, as well as other layers if more than three layers are present. For example, in a three-layer embodiment, such as shown in FIG. 1B, a middle or intermediate layer “C” may comprise 2.5% to 25% of the weight or the total cross-sectional wall thickness of the multilayer article. The middle or intermediate layer may comprise PET and/or PEF (e.g., virgin or recycled) and may include a barrier disposed within the PET in the middle or intermediate layer.

With embodiments, a middle or intermediate layer that includes a barrier layer may, inter alia, serve to separate and/or isolate other layers of a multilayer article. In embodiments, Such as illustrated in FIG. 1B, an inner layer “A” and/or an outer layer “B” may be provided relative to a middle or intermediate layer “C” disposed therebetween. In embodiments, an inner layer (e.g., layer “A”) and/or an outer layer (e.g., layer “B”) may include or contain recycled PET. The inner layer and/or outer layer may include up to 100% PCR PET. Such configurations may avoid incompatibility issues with oxygen scavenging activation and, with embodiments, an associated barrier content level may be reduced to below 1% LDR with nylon-free content. RPET can be included in a middle layer as barrier concentration is comparatively high and it may help to reduce or eliminate an adverse impact of recycled content.

The instant description and accompanying drawings can provide further insights into disclosed multilayer oxygen and/or CO2 barrier technology and some related benefits.

Embodiments of articles may, for example and without limitation, be formed using various known methods in the art, including those involved with injection molding multilayer plastic articles, such as preforms.

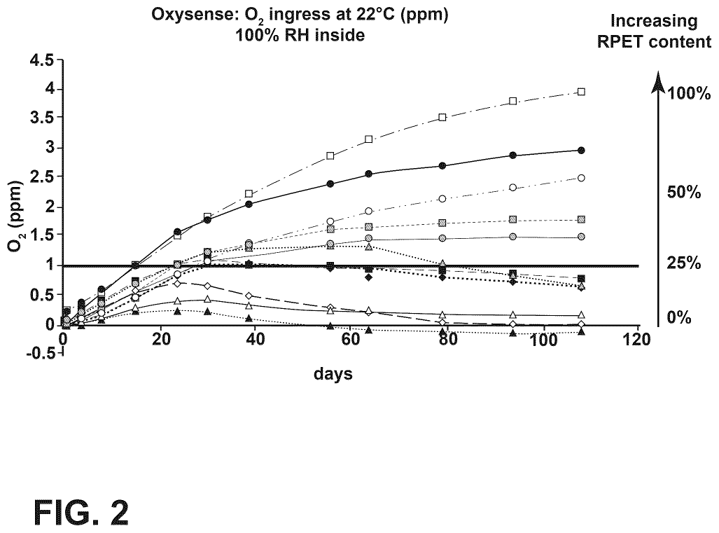

FIG. 2 generally demonstrates an impact of including PCR content within a monolayer article on oxygen and/or CO2 barrier performance. Among other things, the data illustrates how aspects and teachings of the present multilayer disclosure can help overcome incompatibility of recycled PET with barrier material and reduce the impact on barrier activity and enhance recycling stream compatibility.

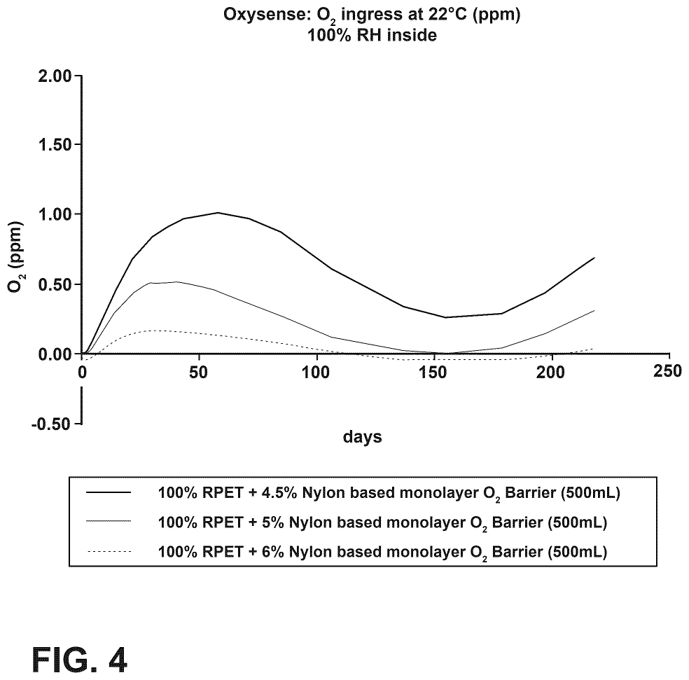

FIG. 4 generally demonstrates the possibility of overcoming negative impact of PCR content with increased barrier % LDR. The data associated with “C” in FIG. 4 generally illustrates barrier performance associated with a 19 gram bottle comprised of 100% recycled PET (RPET) with a 4.5% nylon based mono barrier formula. The data associated with “D” & “E” in FIG. 4 generally illustrate the performance of such a 19 gram 500 ml bottle with increased % LDR of mono-barrier that results in improvement in oxygen scavenging.

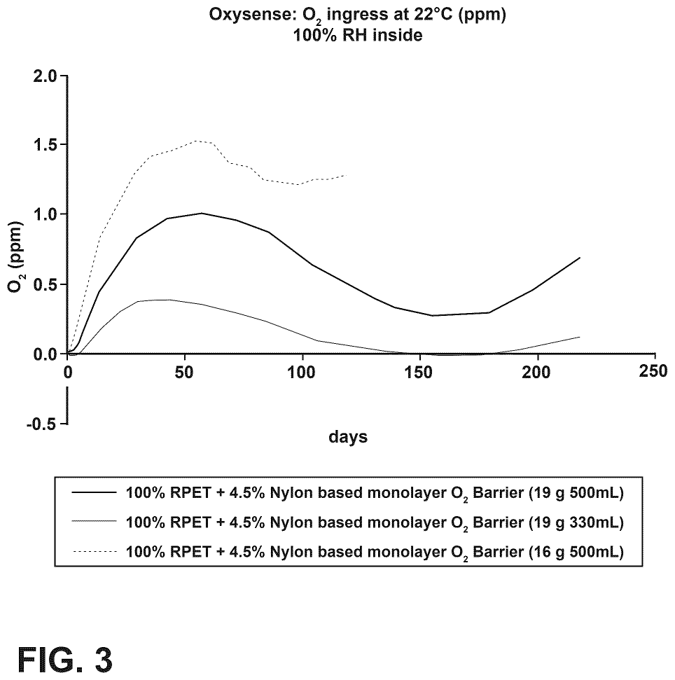

FIG. 3 generally demonstrates barrier performance of light weighted monolayer articles containing RPET. FIG. 3 generally shows a comparison of oxygen barrier performance of bottles containing 100% PCR content blended with 4.5% nylon based barrier. Examples included a standard bottle having average bottle wall thickness of 0.28 mm (19 g 330 ml) and comparatively light-weighted bottles with average bottle wall thickness of 0.22 mm (19 g 500 ml) and 0.18 mm (16 g 500 ml) which indicates an impact of light weighting and eventual decrease of average bottle wall thickness on oxygen barrier performance.

The disclosure demonstrates, inter alia, that increased concentration of barrier formulation can elevate oxygen barrier performance. However, an increased concentration of barrier formulation may have an adverse impact on the color and haze of containers. Not only that, but increased barrier additive may result in the recycling stream contaminating the PCR. Furthermore, such a contaminated PCR may result in incompatibility with barrier material.

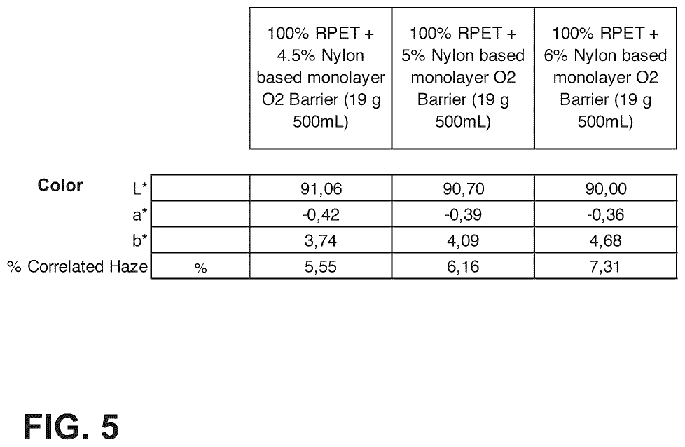

FIG. 5 generally demonstrates the color and haze on the bottles mentioned in FIG. 3 to show an impact of increased barrier concentration in a container. Significant increase in b color and % correlated haze may be observed due to nylon based mono barrier % LDR increase from 4.5% to 6%.

However, overall barrier concentration of a container can be reduced using multilayer configuration of a preform such as illustrated in the embodiment associated with FIG. 1B. For example, and without limitation, a middle layer or intermediate layer in an article (e.g., preform) such as shown in FIG. 1B may include a barrier as disclosed that may be comparatively more highly concentrated with barrier composition and that configuration can function effectively, and even more effectively than other configurations such as a monolayer barrier with similar content. While an overall multilayer article configuration (such as for a multilayer container) may comprise similar percentages of barrier material compared to monolayer embodiments, oxygen barrier performance and visual characteristics associated with the disclosed embodiments of the multilayer articles may be noticeably and significantly improved.

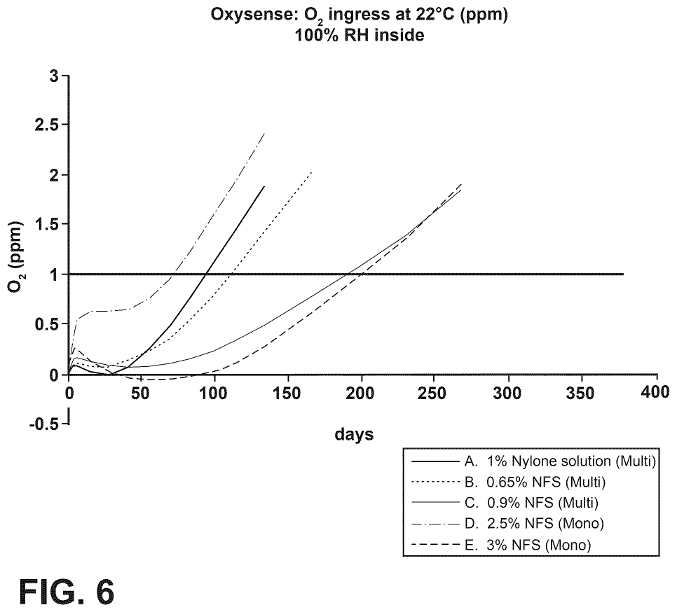

FIG. 6 generally demonstrates barrier performances of different compositions in monolayer and multilayer articles (containers) with nylon and nylon free solutions. Multilayer articles with nylon based barrier are included for reference in comparison with multilayer articles containing nylon free barrier composition. Monolayer articles with nylon free barrier are also included for a comparison of barrier performance with respect to multilayer articles. Composition “A” is a multilayer structured article with a 5% middle or intermediate layer having 20% barrier material within the middle or intermediate layer. The total article contains 1% of nylon based barrier solution. Composition “B” is a multilayer structured article with a 10% middle/intermediate layer (or barrier layer) having 6.5% nylon free solution and only 0.65% barrier material in the total article. Composition “C” prepared with 10% middle or intermediate layer contains 9% nylon free barrier material. Comparatively, 0.65% (B) nylon free barrier material showed better barrier performance with respect to 1% (A) nylon based barrier material in multilayer structure. In accordance with aspects and teachings of the disclosure, an increase in barrier content in the middle or intermediate layer of composition “C” can provide a notable, and even significant, impact on oxygen barrier performance.

Composition D and E in the disclosure associated with FIG. 6 pertain to monolayer articles containing 2.5% and 3% nylon free solutions, respectively, in combination with polyethylene terephthalate (PET). In accordance with aspects and teachings of the present disclosure, multilayer compositions such as disclosed herein, such as those containing 0.65% nylon-free oxygen scavenger (B) and 0.9% nylon-free oxygen scavenger (C), demonstrate similar or better oxygen barrier performance than a monolayer composition having 2.5% nylon-free oxygen scavenger (D) and 3% nylon-free oxygen scavenger (E), respectively.

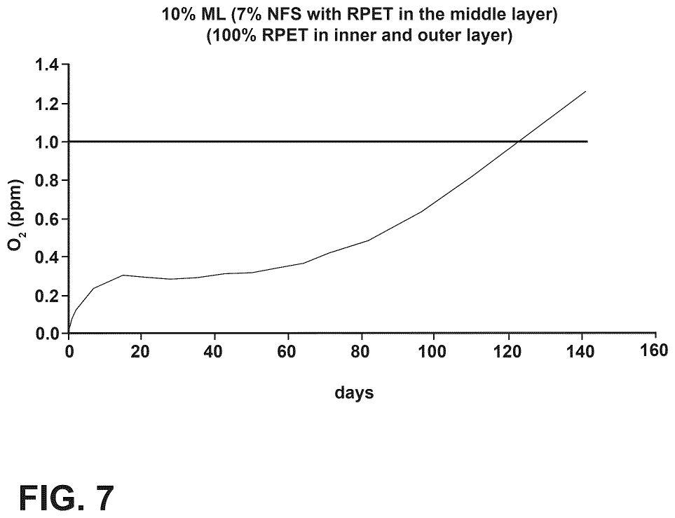

FIG. 7 generally demonstrates barrier performances of multilayer articles (containers) with nylon free solution in combination with recycled PET in all three layers of a three-layer configuration. The composition of “B” associated with FIG. 6 “B” is similar to the composition in FIG. 7.

The composition of the article (e.g., container) in FIG. 7 may comprise a multilayer structure with a 10% middle or intermediate layer, including 7% nylon-free oxygen scavenger as a barrier, and with RPET included in the inner and outer layers. Such an embodiment would include 0.7% nylon-free oxygen scavenger in the total article. With reference to the chart of FIG. 6, an article (e.g., container) such as associated with composition “B” may consist of 10% middle or intermediate layer with 6.5% nylon-free oxygen scavenger, and thus 0.65% nylon-free oxygen scavenger in the total article. However, with the embodiment associated with FIG. 7, all of the (three) layers in the article comprise RPET. That is, the inner and outer layers of the composition comprise 100% RPET and the middle layer includes RPET with nylon free barrier solution, whereas composition “B” in FIG. 6 does not contain any RPET in any of the (three) layers.

Employing multilayer structures with embodiments of articles in accordance with aspects and teachings of the disclosure can, among other things, improve barrier compatibility.

FIG. 2 generally illustrates the influence of RPET content in monolayer articles in connection with barrier performance. Whereas FIG. 6 and FIG. 7 demonstrate similar barrier activity of a 0.65-0.7% nylon-free oxygen scavenger, in total, in embodiments of a multilayer article as disclosed, with or without recycled PET content. Highly concentrated barrier composition in a middle layer may reduce or eliminate an adverse impact of RPET.

Embodiments of multilayer article configurations as disclosed herein may not only improve barrier efficiency of an article but may also provide improved/superior sustainability in view of a reduced or minimized contamination risk in connection with an overall polymer (e.g., PET) article (e.g., bottle). For example, with a multilayer article as disclosed in embodiments, barrier material may be isolated in a middle or intermediate layer. As such, associated discoloration (e.g., yellowing) of the polymer (e.g. PET) may be reduced significantly. Further, the elimination or removal of a barrier layer for certain compositions may also be possible during a recycling process.

In some cases, traces of a barrier material may make it into a recycling stream and may contaminate the stream to a degree. With embodiments of the disclosure, for example to make a barrier compatible with a PET recycling stream, an antioxidant may be combined with a toner (e.g., a blue toner) in inner and/or outer layers. Such a configuration may prevent and/or offset discoloration (e.g., yellowing) in connection with recycling. While a toner alone can reduce yellowing, it can significantly lower the L value (lightness). However, in accordance with embodiments of the present disclosure, a combination of an antioxidant and toner, can permit an L value to be higher (e.g., to stay as high as possible), which can help maintain both a visual appearance and structural integrity of plastic articles (e.g., PET bottles).

Chemical compounds that inhibit oxidation or slow down the oxidation process may be employed as antioxidants. Antioxidants typically involve reduction reactions and neutralize free radicals by giving us their own electrons to prevent the harmful impact of free radicals leading to degradation of organic compounds. In the context of PET bottles, antioxidants may reduce or prevent the degradation and yellowing of the material during processing and recycling. Some examples of antioxidants used in the field include but are not limited to butylated hydroxyanisole (BHA), which may be being used to protect PET from oxidative degradation, butylated hydroxytoluene (BHT), phenolic antioxidant that provides thermal stability and reduces yellowing; phosphite antioxidants such as tris(2,4-di-tert-butylphenyl) phosphite, which may protect PET during high-temperature processing, and phosphonite antioxidants, such as Bis(2,4-di-tert-butylphenyl) pentaerythritol diphosphate, which may enhance the stability of PET.

Additionally, a toner—such a blue toner—may play a role to enhance a lightness (L value) to help offset discoloration, such as yellowing. Some blue toners are designed for complementary color neutralization. In embodiments, when a blue toner is added to PET, the blue toner may absorb and provide neutral color by negating a yellowing effect. Moreover, antioxidants can protect against oxidative damage to further provide material stability and a blue toner can help improve aesthetics, which in general can improve recyclability of a polymer (e.g., PET) with the reduction of discoloration (e.g., yellowing).

In general, addition of such an antioxidant additive may not commonly be implemented in monolayer articles with an active oxygen barrier as the oxygen scavenger and/or an active CO2 barrier may become deactivated by such additive. Among many other reasons for a deactivation of oxygen scavengers, phosphorus metal may have a negative influence on oxygen scavenging as it works as antioxidant.

However, in accordance with aspects and teachings of the disclosure, when an anti-oxidant and toner has been added with an inner and outer layer in a multilayer structure, a middle or intermediate layer with a barrier that is separated may not hinder (or materially hinder) scavenging activity.

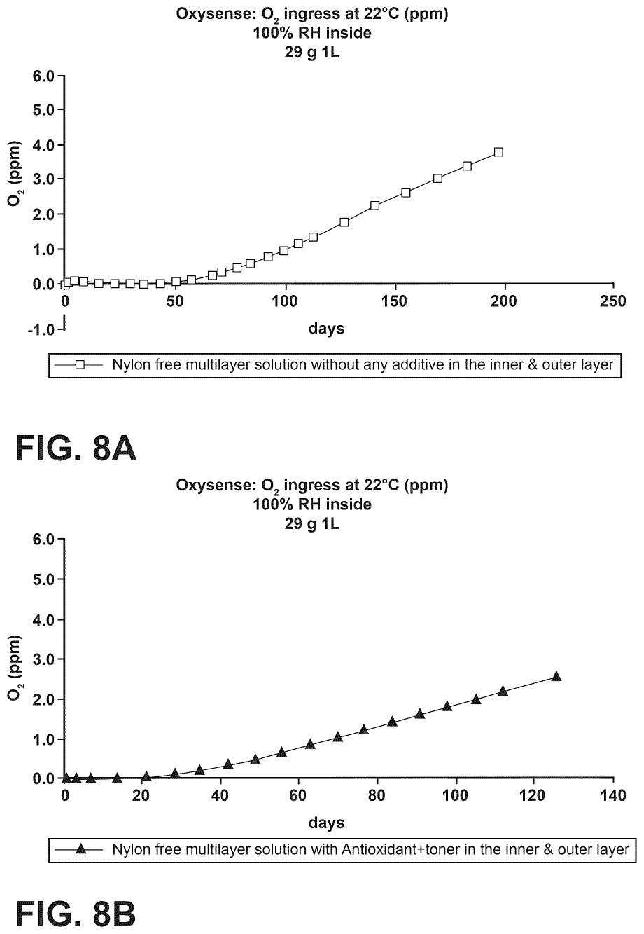

FIG. 8A generally demonstrates barrier performance of a 0.56% nylon free solution (in total multilayer article) without any antioxidant additive in any of the three layers.

FIG. 8B generally demonstrates oxygen barrier performance of multilayer articles where the inner and outer layer contain antioxidant additives in combination with a blue toner. Antioxidant additives are separated from the barrier layer, which can reduce or eliminate the adverse impact of the additives. Nylon based or nylon free oxygen barrier solutions in multilayer structure may be comprised of antioxidant additive with blue toner included in the inner and outer layer.

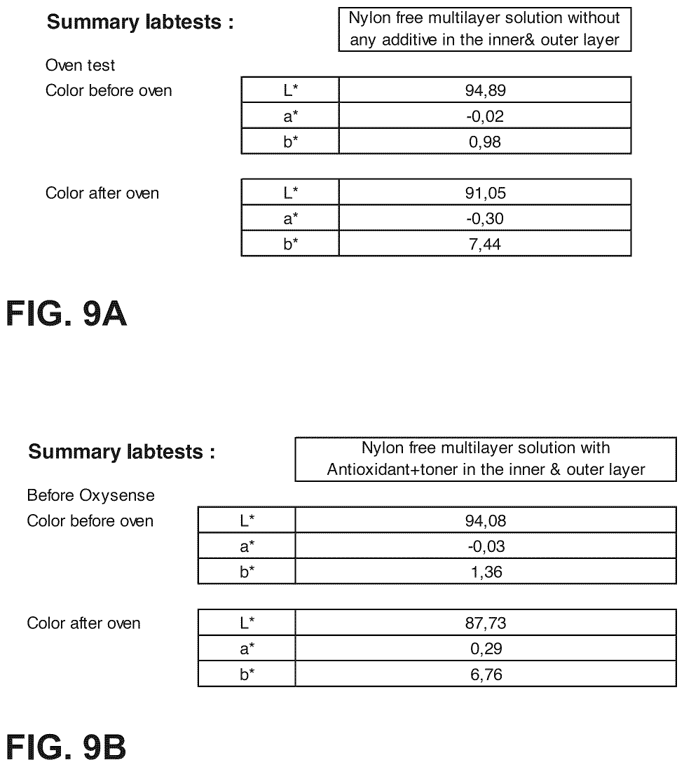

Color (b*) data of the articles related to FIG. 8A and FIG. 8B has been included in the tables of FIG. 9A and FIG. 9B, respectively. Results demonstrate a significant improvement in b color with the addition of an antioxidant additive with blue toner in the inner layer and outer layer.

The disclosure includes, without limitation, the following embodiments:
1. A plastic multilayer article, comprising an inner layer; an outer layer; and a middle or intermediate layer; wherein the inner layer and/or the outer layer include an antioxidant additive; and the middle or intermediate layer includes a polymer and a barrier.
2. The plastic multilayer article of embodiment 1, wherein the polymer of the middle or intermediate layer comprises post consumer recycled (PCR) plastic.
3. The plastic multilayer article of any of the preceding embodiments, wherein the polymer of the middle or intermediate layer comprises polyethylene terephthalate (PET) or polyethylene furanoate (PEF).
4. The plastic multilayer article of any of the preceding embodiments, wherein the inner layer and the outer layer comprise PET.
5. The plastic multilayer article of any of the preceding embodiments, wherein the article comprises a preform.
6. The plastic multilayer article of any of the preceding embodiments, wherein the article comprises a bottle or container.
7. The plastic multilayer article of any of the preceding embodiments, wherein the middle or intermediate layer comprises about 2% to about 25% of a weight or a total cross-sectional wall thickness of the article.
8. The plastic multilayer article of any of the preceding embodiments, wherein the barrier of the middle or intermediate layer is isolated from contact with the inner layer and the outer layer.
9. The plastic multilayer article of any of the preceding embodiments, wherein the antioxidant additive of the inner layer and/or the outer layer includes a toner.
10. The plastic multilayer article of any of the embodiment 9, wherein the toner comprises a blue toner.
11. The plastic multilayer article of any of the preceding embodiments, wherein the barrier comprises an oxygen scavenger.
12. The plastic multilayer article of any of the preceding embodiments, wherein the barrier comprises a CO2 barrier.
13. The plastic multilayer article of embodiment 12, wherein the CO2 barrier comprises a nylon-based barrier.
14. The plastic multilayer article of embodiment 12, wherein the CO2 barrier comprises PEF.
15. The plastic multilayer article of embodiment 12, wherein the CO2 barrier comprises a copolyester.
16. The plastic multilayer article of any of the preceding embodiments, wherein the barrier comprises an oxygen scavenger and a CO2 barrier.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed:

1. A plastic multilayer article, comprising:
an inner layer;
an outer layer; and
a middle or intermediate layer;
wherein the inner layer and/or the outer layer include an antioxidant additive; and the middle or intermediate layer includes a polymer and a barrier.

2. The plastic multilayer article of claim 1, wherein the polymer of the middle or intermediate layer comprises post consumer recycled (PCR) plastic.

3. The plastic multilayer article of claim 1, wherein the polymer of the middle or intermediate layer comprises polyethylene terephthalate (PET) or polyethylene furanoate (PEF).

4. The plastic multilayer article of claim 1, wherein the inner layer and the outer layer comprise PET.

5. The plastic multilayer article of claim 1, wherein the article comprises a preform.

6. The plastic multilayer article of claim 1, wherein the article comprises a bottle or container.

7. The plastic multilayer article of claim 1, wherein the middle or intermediate layer comprises about 2% to about 25% of a weight or a total cross-sectional wall thickness of the article.

8. The plastic multilayer article of claim 1, wherein the barrier of the middle or intermediate layer is isolated from contact with the inner layer and the outer layer.

9. The plastic multilayer article of claim 1, wherein the antioxidant additive of the inner layer and/or the outer layer includes a toner.

10. The plastic multilayer article of claim 9, wherein the toner comprises a blue toner.

11. The plastic multilayer article of claim 1, wherein the barrier comprises an oxygen scavenger.

12. The plastic multilayer article of claim 1, wherein the barrier comprises a CO2 barrier.

13. The plastic multilayer article of claim 12, wherein the CO2 barrier comprises a nylon-based barrier.

14. The plastic multilayer article of claim 12, wherein the CO2 barrier comprises PEF.

15. The plastic multilayer article of claim 12, wherein the CO2 barrier comprises a copolyester.

16. The plastic multilayer article of claim 1, wherein the barrier comprises an oxygen scavenger and a CO2 barrier.
